(19) United States
(12) Patent Application Publication
(10) Pub. No.: US 2014/0059829 A1
(43) Pub. Date: Mar. 6, 2014

(54) BLIND, KEYED DOVETAIL JOINT

(71) Applicants: Mark R. Weber, Chicago, IL (US); Richard J. Theis, Palatine, IL (US)

(72) Inventors: Mark R. Weber, Chicago, IL (US); Richard J. Theis, Palatine, IL (US)

(21) Appl. No.: 13/603,113

(22) Filed: Sep. 4, 2012

(51) Int. Cl. F16B 12/00; B23P 11/00

(52) U.S. Cl. 29/428; 403/381

(57) ABSTRACT

A joint structure includes a tenon and a mortise groove. The tenon has a distal end and a proximal end integral with and extending from a first surface, wherein the distal end includes a planar surface and is wider than the proximal end. The mortise groove has a receiving end and a retaining end formed in a second surface. The first and second surfaces are beveled, and the mortise groove is adapted to receive the tenon such that the tenon is slidable from the receiving end to the retaining end to maintain the first and second surfaces in stationary placement with respect to one another.

### CROSS REFERENCE TO RELATED APPLICATIONS

Not applicable

### BACKGROUND OF THE DISCLOSURE

1. Field of the Background

The present invention generally relates to interlocking joint structures.

2. Description of the Background

The use of dovetail joints to join pieces of wood is well known in the art. A dovetail joint includes at least one mortise and at least one tenon that interlock a first piece of wood and a second piece of wood together, typically at a 90 degree angle. The tenon has a trapezoidal shape that fits into the complimentarily-shaped mortise. More commonly, two structures joined by a dovetail joint include a series of mortises and tenons to create a strong joint. When too few tenons and mortises are used, the resulting joint may be structurally weak.

The dovetail joint comes in a variety of types including a through dovetail joint or a half-blind dovetail joint. A through dovetail joint between two joined members includes a mortise extending fully through the first member such that an end surface of each tenon is coplanar with the outer surface of the first member. Thus, the end surface of each tenon of the through dovetail joint is visible on the outer surface of the first member, and a side surface of each tenon is visible on the outer surface of the second member. In a half-blind dovetail joint, the mortise groove does not extend fully through first member such that the end surface of each tenon of the second member is hidden behind the outer surface of the first member. The side surface of each tenon of the half-blind dovetail joint is visible on the outer surface of the second member.

U.S. Pat. No. 509,364 to Coffeen Jr. discloses a lock mortise and tenon joint for joining a horizontal piece and a vertical piece to enclose paneling of a door. A mortise is formed on the horizontal piece and includes a bored hole at the bottom thereof The bored hole has a diameter wider than the walls of the mortise. A tenon formed on the vertical piece has a rounded edge to fit snugly in the bored hole of the mortise. Convex beveled surfaces are formed adjacent to the mortise, and corresponding concave beveled surfaces are formed adjacent to the tenon. Once the two pieces are square, a staple tack is inserted just below the convex/concave surfaces into the horizontal piece such that the staple spans across the tenon of the vertical piece.

U.S. Pat. No. 4,258,464 to Ullman, Jr. discloses a fastening system including a plug and a socket formation provided on a structure. The plug has a shank with outwardly extending tapered portions forming a frustoconical shape at one end. The socket formation has an enlarged receiving portion having a cylindrical inner wall and a narrower retaining portion extending from the receiving portion to a slot end. The retaining portion is undercut and has a pair of sidewalls that taper to define an undercut slot portion which increases in width with slot depth. The taper of the sidewalls corresponds to the tapered configuration of the tapered portions of the plug. To use the fastening system in a cabinet structure having a shelf with a side surface mounted onto the structure, a plurality of mounting holes is formed in the side surface of the shelf Each mounting hole receives a shank of one of a plurality of plugs and is press-fitted therein. A plurality of plugs is inserted into a plurality of receiving portions of the socket formations formed in the structure and moved into the retaining portions of the plurality of the socket formations.

U.S. Pat. No. 5,193,244 to Meyers discloses a trowel comprising a blade, a support, and a handle having a base along the bottom thereof. The support fixedly mounted on the blade may include a plurality of individual supports that are configured as an inverted truncated cone, The base of the handle includes a plurality of slots to receive the individual supports of the blade. Each slot has a circular inlet opening and a continuous elongate channel having tapered sides that correspond to the inverted truncated cone shape of the individual supports. To attach the handle to the blade, the handle is placed on top of the blade such that the individual supports are inserted into the inlet openings of the slots on the base of the handle. The handle is then displaced longitudinally to force the individual supports into the elongated channels of the slots. The handle is thereby wedged into place and the blade is securely attached thereto.

### SUMMARY OF THE DISCLOSURE

In accordance with one aspect of the present invention, a joint structure includes a tenon and a mortise groove. The tenon has a distal end and a proximal end integral with and extending from a first surface, wherein the distal end includes a planar surface and is wider than the proximal end. The mortise groove has a receiving end and a retaining end formed in a second surface. The first and second surfaces are beveled, and the mortise groove is adapted to receive the tenon such that the tenon is slidable from the receiving end to the retaining end to maintain the first and second surfaces in stationary placement with respect to one another.

According to yet another aspect of the present invention, a furniture kit includes a first part and a second part. The first part has a first surface with a plurality of tenons extending therefrom, wherein each tenon has a distal end and a proximal end integral with the first surface. The second part has a second surface having a plurality of mortise grooves therein, wherein each mortise groove has a receiving end and a retaining end. The first and second surfaces are beveled, and each mortise groove is adapted to receive a corresponding tenon such that the corresponding tenon is slidable from the receiving end to the retaining end to maintain the first and second surfaces in stationary placement with respect to one another.

According to a further aspect of the present invention, a method of assembling furniture, wherein a piece of furniture comprises at least a first part and a second part, includes the steps of obtaining the first part having a first beveled surface with a plurality of tenons extending therefrom and obtaining a second part having a second beveled surface having a plurality of mortise grooves therein. Each tenon has a distal end and a proximal end integral with the first surface. Each mortise groove has a receiving end and a retaining end. The method further includes the steps of inserting each tenon into the receiving end of a corresponding mortise groove and slidingly engaging the plurality of tenons with the plurality of retaining ends of the plurality of mortise grooves.

According to a still further aspect of the present invention, a method of assembling furniture comprising a plurality of parts, wherein a first part has a first beveled surface with a plurality of tenons extending therefrom and a second part having a second beveled surface having a plurality of mortise grooves therein, is provided. Each tenon has a distal end and a proximal end integral with the first surface. Each mortise groove has a receiving end and a retaining end. The method includes the steps of inserting each tenon into the receiving end of a corresponding mortise groove and slidingly engaging the plurality of tenons with the plurality of retaining ends of the plurality of mortise grooves.

Other aspects and advantages of the present invention will become apparent upon consideration of the following detailed description and the attached drawings.

### BRIEF DESCRIPTION OF THE DRAWINGS

FIG. 1 is an exploded isometric view of a first surface and a second surface spaced apart and that together form a blind, keyed dovetail joint;

FIG. 2 is a sectional view taken generally along the lines 2-2 of FIG. 1;

FIG. 3A is a sectional view taken generally along the lines 3A-3A of FIG. 1;

FIG. 3B is a sectional view taken generally along the lines 3B-3B of FIG. 1;

FIG. 4 is an isometric view of a first surface and a second surface forming a blind, keyed dovetail joint;

FIG. 5A is a sectional view taken generally along the lines 5A-5A of FIG. 1 of a first surface and a second surface joined together as shown in FIG. 4;

FIG. 5B is a sectional view taken generally along the lines 5B-5B of FIG. 1 of a first surface and a second surface joined together as shown in FIG. 4;

FIG. 6 is an exploded isometric view of a stool utilizing the blind, keyed dovetail joint;

FIG. 7 is a plan view of a seat of the stool utilizing the blind, keyed dovetail joint from below; and

FIG. 8 is a side elevational view of an inside surface of a side panel of the stool utilizing the blind, keyed dovetail joint.

### DETAILED DESCRIPTION OF THE DRAWINGS

As shown in the attached FIGS., the blind, keyed dovetail joint 10 of the present invention comprises a tenon 20 integral with and extending from a first surface 14, and a mortise groove 28 formed in a second surface 18. In the drawings, like reference numerals connote like structures throughout.

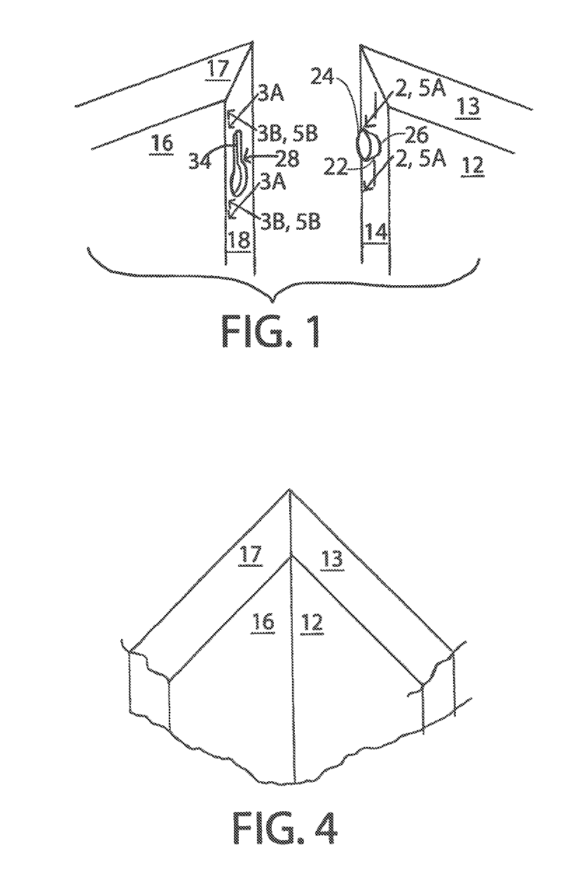

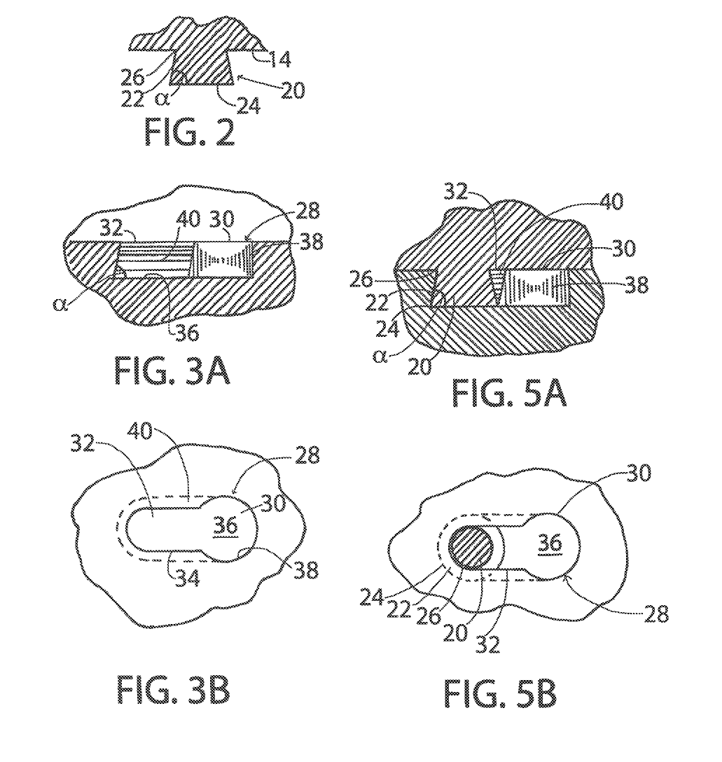

Referring to FIG, 1, the blind, keyed dovetail joint 10 is formed between a first panel 12 having a first surface 14 and a second panel 16 having a second surface 18. At least one tenon 20, and preferably a plurality of tenons 20, project from the first surface 14. As shown in FIGS. 1 and 2, each tenon 20 includes a frustoconical side surface 22 having a wider distal end 24 and a smaller proximal end 26. The frustoconical side surface 22 forms an acute angle α with the distal end 24 as seen in FIG, 2. The distal end 24 may include a planar surface, but is not limited thereto.

At least one mortise groove 28 is formed on the second surface 18. Referring to FIGS. 1, 3A, and 3B, each mortise groove 28 has a receiving end 30 and a retaining end 32 and includes a key-shaped opening 34 and a recessed surface 36. The receiving end 30 includes a round portion of the key-shaped opening 34 and is defined by walls 38 perpendicular to the recessed surface 36. The receiving end 30 is sized to accept fully the distal end 24 of the tenon 20. The number of mortise grooves 28 corresponds to the number of tenons 20.

As shown in FIG, 3A, the retaining end 32 includes a longitudinal portion of the key-shaped opening 34 and has tapered walls 40 that form an angle α with the recessed surface 36. The longitudinal portion of the key-shaped opening 34 is sized to receive the proximal end 26 of the tenon 20. The tapered walls 40 of the retaining end 32 complement and are sized to receive the frustoconical side surface 22 of the tenon 20 such that the tenon 20 is held in a retained position. The recessed surface 36 is sized to receive the distal end 24 of the tenon 20 throughout the length of the mortise groove 28. In the preferred embodiment, the angle α is acute. In other embodiments, the mortise groove 28 may include a transitional area between the receiving end 30 and the retaining end 32. The transitional area may include lead-in surfaces, ramps, or other types of surfaces that urge the tenon 20 toward the retained position.

In some embodiments, the tenon 20 may include an intermediate portion having walls perpendicular to the first surface 14 at the proximal end 26 adjacent the frustoconical side surface 22. The intermediate portion may be cylindrical but is not limited thereto. The mortise groove 28 must be modified to hold the tenon 20 having an intermediate portion in a secure manner.

FIGS. 4, 5A, and 5B show the blind, keyed dovetail joint 10 in an assembled condition. During assembly, the tenon 20 is inserted into the receiving end 30 of the mortise groove 28 and slidingly engages with the retaining end 32 of the mortise groove 28. Referring to FIGS. 5A and 513, the frustoconical side surfaces 22 fully engage associated tapered walls 40 of the retaining end 32 to hold the two surfaces firmly together in stationary placement with respect to one another when assembled. In the preferred embodiment, the first surface 14 and the second surface 18 are in contact and the blind, keyed dovetail joint 10 is hidden from sight when in use as illustrated in FIG. 4. Also referring to FIG. 4, the tenons 20 and the mortise grooves 28 are positioned such that a first top surface 13 of the first panel 12 and a second top surface 17 of the second panel 16 are coplanar when the blind, keyed dovetail joint 10 is in an assembled condition.

In some embodiments, the blind, keyed dovetail joint 10 may comprise a plurality of tenons 20 integral with and extending from the first surface 14 of the first panel 12 and a plurality of corresponding mortise grooves 28 in the second surface 18 of the second panel 16 to increase the strength of the joint. The tenons 20 included in the plurality of tenons 20 and mortise grooves 28 included in the plurality of mortise grooves 28 are identical to those described above. The number and shaping of the tenons 20 and the mortise grooves 28 may vary depending on the structural needs. The tenons 20 and mortise grooves 28 may be equally or unequally spaced along the first and second surfaces 14, 18, respectively. In a preferred embodiment, the tenons 20 are spaced equidistant from one another, as are the mortise grooves 28. The spacing between adjacent tenons 20 may vary depending on the scale of the lumber and other design requirements and/or features. In the preferred embodiment, each tenon 20 of the plurality of tenons 20 is spaced apart from an adjacent tenon 20 up to about three inches on center. Also in this embodiment, each mortise groove 28 is spaced from an adjacent mortise groove by the same distance.

Referring to the FIGS., the first and second surfaces 14, 18 of the first and second panels 12, 16 are beveled and planar for a mitered corner joint. In some embodiments, the blind, keyed dovetail joint 10 may be formed on other surfaces such as perpendicular butt joints. The blind, keyed dovetail joint 10 can be used in many applications such as furniture design.

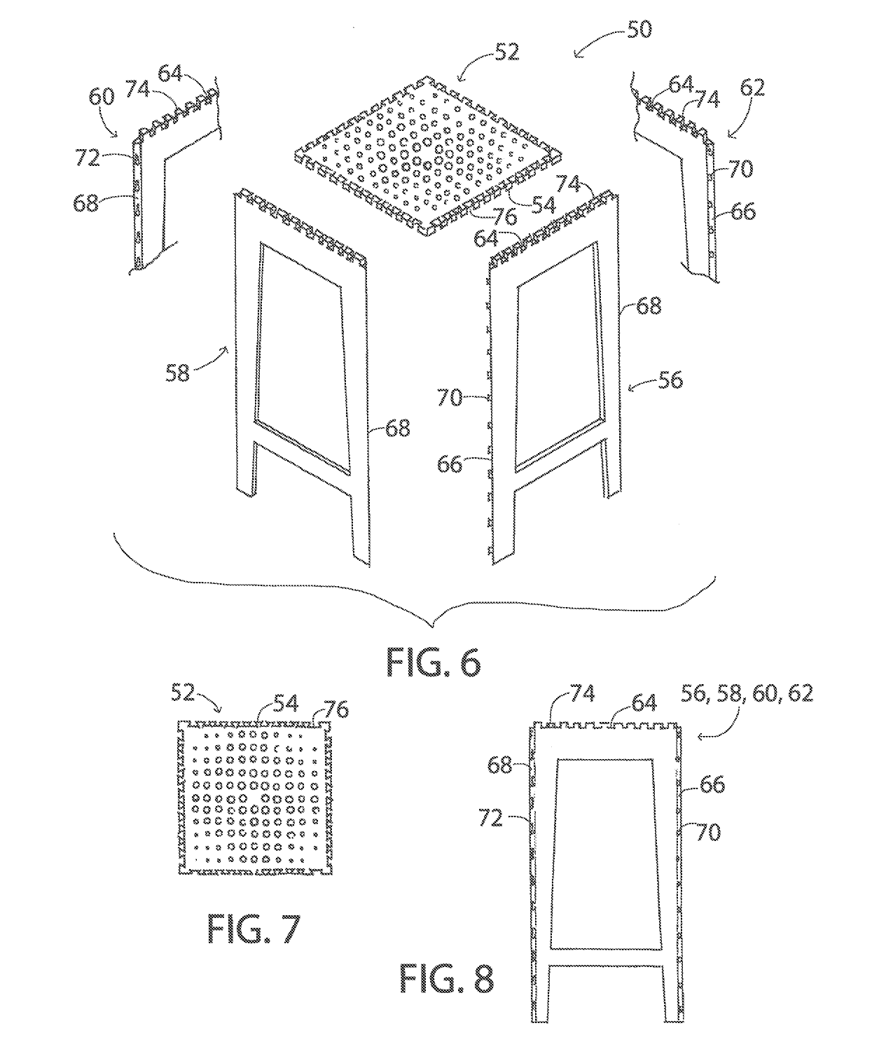

FIGS. 6-8 demonstrate the use of the blind, keyed dovetail joint 10 in the construction of a stool 50. The stool 50 includes a seat 52 having four side surfaces 54 and four side panels 56, 58, 60, 62. Each panel 56, 58, 60, 62 includes an end surface 64, a first side surface 66, and a second side surface 68. The blind, keyed dovetail joint 10 is utilized between the first side surfaces 66 and the second side surfaces 68 of adjacent panels 56, 58, 60, 62. A plurality of tenons 70 formed integral with and extending from the first side surface 66 of side panel 56, 58, 60, 62 mate with a corresponding second plurality of mortise grooves 72 formed in the second side surface 68 of an adjacent panel 58, 60, 62, 56, respectively. The tenons 70 and the mortise grooves 72 are identical to the tenons 20 and mortise grooves 28 described above. A typical through dovetail joint is utilized between the side surfaces 54 of the seat 52 and the end surfaces 64 of each side panel 56, 58, 60, 62. A series of standard trapezoidal tenons 74 are formed integral with each end surface 58 of each panel 56, 58, 60, 62. A corresponding series of standard mortise grooves 76 sized to receive the standard trapezoidal tenons 74 are formed in each side surface 54 of the seat 52.

Construction of the stool 50 will now be described. Referring to FIG. 6, the plurality of tenons 70 extending from the first side surface 66 of panel 56 are inserted into the receiving ends 30 of the plurality of mortise grooves 72 in the second side surface 68 of panel 58. The plurality of tenons 70 of the panel 56 are moved into the retaining ends 32 of the plurality of mortise grooves 72 of the panel 58 such that the end surfaces 64 of the panels 56, 58 are coplanar. This process is repeated for the plurality of tenons 70 and the plurality of mortise grooves 72 of the panels 58, 60, the panels 60, 62, and the panels 62, 56. Once the panels 56, 58, 60, 62 are joined, the plurality of standard tenons 74 on the side surfaces 54 of the seat 52 are inserted into the plurality of standard mortise grooves 76 on the end surfaces 64 of the panels 56, 58, 60, 62.

Further, furniture comprising the blind, keyed dovetail joint 10 may be provided in a furniture kit for easy assembly. The furniture kit may comprise a first part having a first surface 14 with a plurality of tenons 20 extending therefrom, and a second part having a second surface 18 having a plurality of mortise grooves 28 therein. The first surface 14, the second surface 18, the plurality of tenons 20 and the plurality of mortise grooves 28 are identical to those described above.

Formation of the frustoconical side surface 20 of the tenon 18 and the tapered walls 36 of the mortise groove 28 may be performed by a variety of means including but not limited to a computer numerical control (CNC) machine. Such a machine provides a sufficient degree of accuracy necessary to create close-fitting complimentary pieces of a tenon and mortise groove joint in a blind, keyed formation.

The blind, keyed dovetail joint 10 may be formed from any material including but not limited to wood and steel. Other embodiments of the disclosure including all the possible different and various combinations of the individual features (including elements and process steps) of each of the foregoing described embodiments and examples are specifically included herein.

### INDUSTRIAL APPLICABILITY

The blind, keyed dovetail joint described herein advantageously allows for easy assembly of strong joints that are hidden from view.

Numerous modifications to the present disclosure will be apparent to those skilled in the art in view of the foregoing description. Accordingly, this description is to be construed as illustrative only and is presented for the purpose of enabling those skilled in the art to make and use the present disclosure and to teach the best mode of carrying out same.

We claim:

1. A joint structure, comprising:
a tenon having a distal end and a proximal end integral with and extending from a first surface, wherein the distal end includes a planar surface and is wider than the proximal end; and
a mortise groove having a receiving end and a retaining end formed in a second surface;
wherein the first and second surfaces are beveled and the mortise groove is adapted to receive the tenon such that the tenon is slidable from the receiving end to the retaining end to maintain the first and second surfaces in stationary placement with respect to one another.

2. The joint structure of claim 1, wherein the tenon has walls that are tapered and form an acute angle with the first surface.

3. The joint structure of claim 2, wherein the retaining end of the mortise groove has an opening, walls, and a recessed surface.

4. The joint structure of claim 3, wherein the opening of the retaining end of the mortise groove is sized to receive the proximal end of the tenon and the recessed surface of the retaining end of the mortise groove is sized to receive the distal end of the tenon.

5. The joint structure of claim 4, wherein the walls of the retaining end are tapered and complement the walls of the tenon.

6. The joint structure of claim 1, wherein the first and second surfaces and the tenon are a wood material.

7. The joint structure of claim 1, wherein the first and second surfaces are planar.

8. The joint structure of claim 1, wherein the first surface is in contact with the second surface when assembled.

9. A piece of furniture, comprising the joint structure of claim 1.

10. The piece of furniture of claim 9, wherein the piece of furniture is a stool.

11. The joint structure of claim 1, comprising a plurality of tenons and a plurality of mortise grooves.

12. The joint structure of claim 11, wherein each tenon is spaced apart from an adjacent tenon up to about three inches on center.

13. A furniture kit, comprising:
a first part having a first surface with a plurality of tenons extending therefrom, wherein each tenon has a distal end and a proximal end integral with the first surface; and
a second part having a second surface having a plurality of mortise grooves therein, wherein each mortise groove has a receiving end and a retaining end;
wherein the first and second surfaces are beveled and each mortise groove is adapted to receive a corresponding tenon such that the corresponding tenon is slidable from the receiving end to the retaining end to maintain the first and second surfaces in stationary placement with respect to one another.

14. The furniture kit of claim 13, wherein each tenon has walls that are tapered and form an acute angle with the first surface, wherein the retaining end of each mortise groove has an opening that is sized to receive the proximal end of the corresponding tenon, a recessed surface that is sized to receive the distal end of the corresponding tenon, and walls that are tapered and complement the walls of the corresponding tenon.

15. A method of assembling furniture, wherein a piece of furniture comprises at least a first part and a second part, comprising the steps of:
obtaining the first part having a first beveled surface with a plurality of tenons extending therefrom, wherein each tenon has a distal end and a proximal end integral with the first surface;
obtaining a second part having a second beveled surface having a plurality of mortise grooves therein, wherein each mortise groove has a receiving end and a retaining end;
inserting each tenon into the receiving end of a corresponding mortise groove; and
slidingly engaging the plurality of tenons with the plurality of retaining ends of the plurality of mortise grooves.

16. The method of claim 15, wherein the tenon has walls that tapered and form an acute angle with the first surface.

17. The method of claim 15, wherein the retaining end of the mortise groove has an opening, walls, and a recessed surface, and wherein the opening of the retaining end of the mortise groove is sized to receive the proximal end of the tenon and the recessed surface of the retaining end of the mortise groove is sized to receive the distal end of the tenon.

18. A method of assembling furniture comprising a plurality of parts, wherein a first part has a first beveled surface with a plurality of tenons extending therefrom, wherein each tenon has a distal end and a proximal end integral with the first surface, and a second part having a second beveled surface having a plurality of mortise grooves therein, wherein each mortise groove has a receiving end and a retaining end, comprising the steps of:
inserting each tenon into the receiving end of a corresponding mortise groove; and
slidingly engaging the plurality of tenons with the plurality of retaining ends of the plurality of mortise grooves.

19. The method of claim 18, wherein the tenon has walls that are tapered and form an acute angle with the first surface.

20. The method of claim 18, wherein the retaining end of the mortise groove has an opening, walls, and a recessed surface, and wherein the opening of the retaining end of the mortise groove is sized to receive the proximal end of the tenon and the recessed surface of the retaining end of the mortise groove is sized to receive the distal end of the tenon.
